(19) United States
(12) Patent Application Publication
(10) Pub. No.: US 2013/0059475 A1
(43) Pub. Date: Mar. 7, 2013

(54) USB Connector

(71) Applicants: Qingsong Shi, Shenzhen City (CN); Yanbin Zhang, Shenzhen City (CN); Ning Liu, Shenzhen City (CN); Xi Yang, Shenzhen City (CN)

(72) Inventors: Qingsong Shi, Shenzhen City (CN); Yanbin Zhang, Shenzhen City (CN); Ning Liu, Shenzhen City (CN); Xi Yang, Shenzhen City (CN)

(73) Assignee: ZTE CORPORATION, Shenzhen City, Guangdong Province (CN)

(21) Appl. No.: 13/258,426

(22) PCT Filed: Aug. 25, 2010
(86) PCT No.: PCT/CN2010/076358

§ 371 Date: Sep. 21, 2011

(30) Foreign Application Priority Data
May 25, 2010 (CN) 201020205787.2

(51) Int. Cl. H01R 24/28

(52) U.S. Cl. 439/626

(57) ABSTRACT

The present invention discloses a USB connector, comprising: a USB shell, an insulation spacer, metal sheets with metal weld legs respectively. The metal sheets are installed on the insulation spacer, the metal sheets are configured to be connected to a USB interface of a personal computer, the metal weld legs are connected to a printed circuit board within an external product, and the insulation spacer is fixed in the USB shell; the metal sheets comprise one ground pin, two signal pins and one power supply pin, wherein the ground pin is configured with an extending resilient metal sheet contacted with the USB shell. Widths of the metal sheets and the metal weld legs are widen and thicknesses of the metal sheets and the insulation spacer are thicken, so that the USB connector and the USB interface of the computer are contacted sufficiently, enhancing the ground effect of the USB connector.

### TECHNICAL FIELD

The present invention relates to a universal serial bus (USB) device, and particularly, to a USB connector.

### BACKGROUND OF THE RELATED ART

In recent years, USB device is rapidly spread due to the following advantages such as, supporting hot swap, being compact and lightweight, providing a standard interface to widely accept a variety of devices, being low cost, and so on.

The USB device in the prior art typically comprises a metal shell, a plastic pad, four metal sheets and four metal weld legs. Wherein, the metal shell is used to protect the metal sheets and metal weld legs within the USB connector. The shape and size of the metal shell should require to satisfy requirements of USB industry standard. One side of the plastic pad is fixed within the metal shell, and the other side is installed with the four metal sheets and the four metal weld legs which are integrated with the four metal sheets. The metal weld legs are connected to a printed circuit board within a product using the USB connector. In use, the metal sheets are contacted with a USB interface of a computer directly, and communication between the computer and the product using the USB connector is implemented by the metal weld legs.

The plastic pad within the existing conventional USB connector and the four metal sheets fixed on the plastic pad are relatively thin on a whole. The four metal sheets are relatively narrow, and each of the metal sheets has some bulge at the center part. Therefore, contact portions between the metal sheet and the USB interface of the computer are only limited to the portion of the bulge at the center part of each metal sheet, resulting in the contact between the USB connector and the USB interface of the computer insufficient, which easily causes the problem of poor contact. Above all, a ground pin in the metal sheet and the metal shell of the USB connector are not conducted, resulting in a poor ground effect of the USB connector, and then electromagnetic interference from the computer is not conducted to the ground well, thereby influencing wireless performance of wireless broadband products.

### CONTENT OF THE INVENTION

The embodiments of the present invention provide a USB connector, which can implement sufficiently contact with the USB interface of the computer and can enhance the ground effect of the USB connector.

A USB connector comprises: a USB shell, an insulation spacer, and metal sheets with metal weld legs respectively, wherein,

the metal sheets are installed on the insulation spacer, the metal sheets are configured to be connected to a USB interface of a personal computer, the metal weld legs are connected to a printed circuit board within an external product, and the insulation spacer is fixed in the USB shell; and

the metal sheets comprise one ground pin, two signal pins and one power supply pin, wherein the ground pin is configured with an extending resilient metal sheet in contact with the USB shell.

The USB connector can have the following characteristics: a surface of each metal sheet is in a flat form.

The USB connector can also have the following characteristics: the extending resilient metal sheet is a resilient metal sheet with a bending shape, which extends from the ground pin.

The USB connector can also have the following characteristics: widths of the ground pin and the power supply pin are 1.5 mm to 2 mm, and a width of each signal pin is 1.1 mm to 1.3 mm.

The USB connector can also have the following characteristics: the metal weld legs comprise one ground weld leg, two signal weld legs and one power supply weld leg, which are integrated with one ground pin, two signal pins and one power supply pin, respectively; wherein, widths of the ground weld leg and the power supply weld leg are 0.8 mm to 1.7 mm, and a width of each signal weld leg is 0.8 mm to 1.2 mm.

The USB connector can also have the following characteristics: a sum of thicknesses of the insulation spacer and the metal sheets are 2.3 mm to 2.45 mm.

The USB connector can also have the following characteristics: the insulation spacer has a plastic material.

The USB connector can also have the following characteristics: the USB shell has a metal material.

The USB connector in the embodiments of the present invention adds one extending resilient metal sheet on the ground pin in the metal sheet, thus the USB connector can enhances the ground effect of the USB connector and can conduct the electromagnetic interference from the computer to the ground well, thereby enhancing the wireless performance of the wireless broadband products.

### BRIEF DESCRIPTION OF DRAWINGS

FIG. 1 is a profile structural diagram of a USB connector in an embodiment of the present invention; and

FIG. 2 is a front structural diagram of a USB connector in an embodiment of the present invention.

### PREFERRED EMBODIMENTS OF THE PRESENT INVENTION

The embodiments of the present invention provide a USB connector, which can implement sufficiently contact with a USB interface of a computer and can enhance the ground effect of the USB connector. In addition, the USB connector can conduct the electromagnetic interference from the computer to the ground well, thus enhancing the wireless performance of the wireless broadband products.

The USB connector comprises a USB shell, an insulation spacer, and metal sheets with metal weld legs respectively, wherein, the metal sheets are installed on the insulation spacer, the metal sheets are used to be connected to the USB interface of a personal computer (PC), the metal weld legs are connected to a printed circuit board within an external product, and the insulation spacer is fixed in the USB shell; and the metal sheets comprise one ground pin, two signal pins and one power supply pin, wherein, the ground pin is configured with an extending resilient metal sheet contacted with the USB shell.

The function of the insulation spacer is mainly to underlay the metal sheets, so that the metal sheets can properly achieve a contact with the USB interface of the computer, and meanwhile, achieve an insulation between the metal sheets and the USB shell.

The extending resilient metal sheet can enhance the ground effect of the USB connector, and can conduct the electromagnetic interference from the computer well to the ground, thus enhancing the wireless performance of the wireless broadband products.

Preferably, the surface of the metal sheet is in a flat form, which can better contact with the USB interface of the PC.

Preferably, the extending resilient metal sheet is a resilient metal sheet with a bending shape which extends from the ground pin.

Preferably, the widths of the ground pin and the power supply pin are 1.5 mm to 2 mm, and the width of each signal pin is 1.1 mm to 1.3 mm.

Preferably, the metal weld legs comprise one ground weld leg, two signal weld legs and one power supply weld leg, which are integrated with one ground pin, two signal pins and one power supply pin, respectively, wherein, the widths of the ground weld leg and the power supply weld leg are 0.8 mm to 1.7 mm, and the width of each signal weld leg is 0.8 mm to 1.2 mm.

Preferably, the sum of thicknesses of the insulation spacer and the metal sheets are 2.3 mm to 2.45 mm.

The USB connector can better contact with the USB interface of the PC by increasing the widths of the metal sheets and the metal weld legs and thickening the thicknesses of the insulation spacer and the metal sheets.

Preferably, the insulation spacer has a plastic material.

Preferably, the USB shell has a metal material.

Hereinafter, the USB connector in the present invention will be described in detail in combination with a preferable embodiment.

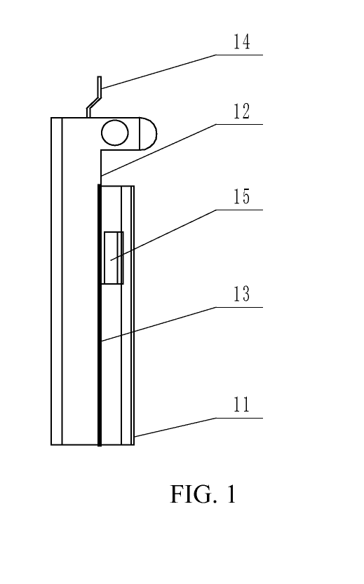

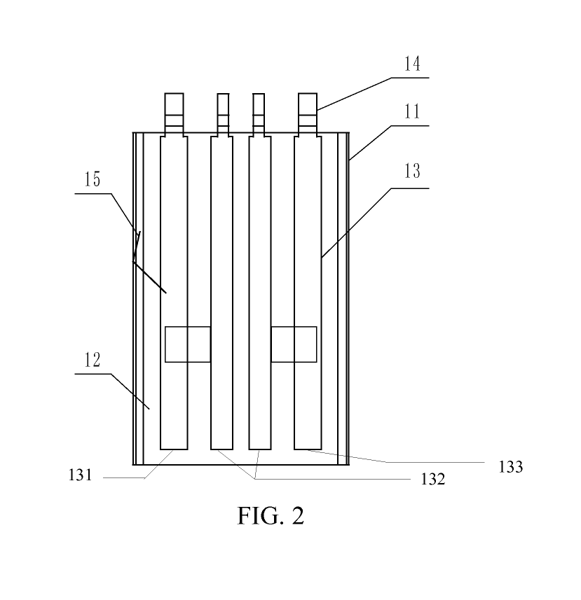

The embodiment of the present invention provides a USB connector, as shown in FIG. 1. FIG. 1 is a profile structural diagram of the USB connector, and FIG. 2 is a front structural diagram of the USB connector. The USB connector comprises a metal shell 11, i.e., the USB shell, a plastic pad 12, metal sheets 13, metal weld legs 14 and an extending resilient metal sheet 15. Wherein, the shape and size of the metal shell 11 should require to satisfy the requirements of USB connector industry standards, and the metal shell 11 is used to fix the plastic pad 12. The plastic pad 12 is designed in accordance with the standard length and width sizes of the USB, and four metal sheets 13 is installed on the plastic pad 12, as shown in FIG. 2, which in turn are one ground pin 131, two signal pins 132 and one power supply pin 133 from left to right. The four metal sheets are used to contact with the USB interface of the computer. In order to make the contact more sufficient, in the present invention, the four metal sheets are made into a flat form, instead of having bulges at the center as the metal sheets in the prior art, which increases the contact area between the metal sheets and the USB interface of the computer, thus enhancing the contact effect. In addition, in order to further increase the contact area, the widths of the four metal sheets are widen properly. For example, the ground pin 131 is widen to the width between 1.5 mm and 2 mm, including 1.5 mm and 2 mm; the two signal pins 132 are widen to the widths between 1.1 mm and 1.3 mm, including 1.1 mm and 1.3 mm; and the power supply pin 133 is widen to the width between 1.5 mm and 2 mm, including 1.5 mm and 2 mm. Four metal weld legs 14 are further installed on the plastic pad 12. These four metal weld legs 14 are integrated with the four metal sheets 13 respectively; for example, the ground weld leg in the four weld legs is integrated with the ground pin in the metal sheets, the two signal weld legs in the weld legs are integrated with the two signal pins in the metal sheets, and the power supply weld leg in the weld legs is integrated with the power supply pin in the metal sheets. The weld legs are connected to the printed circuit board within a product using the USB connector, which are mainly used to connect the metal sheets with the printed circuit board, thus implementing the communication between the computer and the product using the USB. The widths of the weld legs are typically smaller than the widths of the corresponding metal sheets. In the present invention, in order to achieve a better contact between the weld legs with the printed circuit board and the metal sheets, the widths of the weld legs are properly widen; for example, the ground weld leg and the power supply weld leg are widen to the widths between 0.8 mm and 1.7 mm, including 0.8 mm and 1.7 mm; and the two signal weld legs are widen to the widths between 0.8 mm and 1.2 mm, including 0.8 mm and 1.2 mm. In the embodiment of the present invention, in order to achieve a better contact between the USB connector and the USB interface of the computer, the thicknesses of the plastic pad 12 and the four metal sheets 13 are properly thicken, so that the overall thickness of the plastic pad and the four metal sheets are between 2.3 mm and 2.45 mm, including 2.3 mm and 2.45 mm. In addition, in order to achieve electrical conduction in the USB connector, thus enhancing the ground effect of the USB connector, in the embodiment of the present invention, the extending resilient metal sheet 15 is designed on the ground pin 131 in the metal sheets 13. The extending resilient metal sheet 15 is integrated with the ground pin 131, and is in contact with the metal shell 11, thus enhancing the ground effect of the USB connector, and then can conduct the electromagnetic interference from the computer well to the ground, thus enhancing the wireless performance of the wireless broadband products.

The USB connector in the embodiment of the present invention can make the contact between the USB connector and the USB interface of the computer more sufficient by widening the widths of the metal sheets and the metal weld legs, thickening the thicknesses of the plastic pad and the mental sheets and making the metal sheets into a flat form; can implement the electrical conduction in the USB connector by adding the extending resilient metal sheet contacted with the metal shell and on the ground pin of the metal sheets, thus enhancing the ground effect of the USB connector; and can conduct the electromagnetic interference from the computer well to the ground, thus enhancing the wireless performance of the wireless broadband products.

Those skilled in the art can understand that all or part of steps in the above-described method can be fulfilled by programs instructing the related hardware. The programs can be stored in a computer readable storage media, such as a read-only memory, a magnetic disk, or an optical disk, etc. Alternatively, all or part of the steps in the above-described embodiments can be implemented by one or more integrated circuits. Correspondingly, each module/unit in the above embodiments can be implemented in the form of hardware, or in the form of software functional module. The present invention is not limited to any specific combination form of the hardware and software.

Obviously, those skilled in the art can make various modifications and variations on the present invention without departing from the spirit and scope of the present invention. Thus, if these modifications and variations of the present invention belong to the scope of the appending claims of the present invention and the equivalent technologies thereof, the invention is also intended to include these modifications and variations in.

### INDUSTRIAL APPLICABILITY

The USB connector provided by the embodiments of the present invention can make the contact between the USB connector and the USB interface of the computer more sufficient by widening the widths of the metal sheets and the metal weld legs, thickening the thicknesses of the plastic pad and the mental sheets and making the metal sheets into a flat form; can implement the electrical conduction in the USB connector by adding the extending resilient metal sheet contacted with the metal shell and on the ground pin of the metal sheets, thus enhancing the ground effect of the USB connector; and can conduct the electromagnetic interference from the computer well to the ground, thus enhancing the wireless performance of the wireless broadband products.

What is claimed is:

1. A USB connector, comprising: a USB shell, an insulation spacer, and metal sheets with metal weld legs respectively, wherein,
the metal sheets are installed on the insulation spacer, the metal sheets are configured to be connected to a USB interface of a personal computer, the metal weld legs are connected to a printed circuit board within an external product, and the insulation spacer is fixed in the USB shell; and
the metal sheets comprise one ground pin, two signal pins and one power supply pin, wherein the ground pin is configured with an extending resilient metal sheet in contact with the USB shell.

2. The USB connector according to claim 1, wherein, a surface of each metal sheet is in a flat form.

3. The USB connector according to claim 1, wherein, the extending resilient metal sheet is a resilient metal sheet with a bending shape, which extends from the ground pin.

4. The USB connector according to claim 1, wherein, widths of the ground pin and the power supply pin are 1.5 mm to 2 mm, and a width of each signal pin is 1.1 mm to 1.3 mm.

5. The USB connector according to claim 1, wherein, the metal weld legs comprise one ground weld leg, two signal weld legs and one power supply weld leg, which are integrated with one ground pin, two signal pins and one power supply pin, respectively; wherein, widths of the ground weld leg and the power supply weld leg are 0.8 mm to 1.7 mm, and a width of each signal weld leg is 0.8 mm to 1.2 mm.

6. The USB connector according to claim 1, wherein, a sum of thicknesses of the insulation spacer and the metal sheets are 2.3 mm to 2.45 mm.

7. The USB connector according to claim 1, wherein, the insulation spacer has a plastic material.

8. The USB connector according to claim 1, wherein, the USB shell has a metal material.
